(19) United States
(12) Patent Application Publication
(10) Pub. No.: US 2008/0266243 A1
(43) Pub. Date: Oct. 30, 2008

(54) Electrophoretic Display Panel

(75) Inventors: Mark Thomas Johnson, Eindhoven (NL); Guofu Zhou, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,526

(22) PCT Filed: Jan. 25, 2005
(86) PCT No.: PCT/IB05/50284

§ 371 Date: Jul. 28, 2006

(30) Foreign Application Priority Data
Feb. 2, 2004 (EP) 04100357.5

(51) Int. Cl. G09G 3/34

(52) U.S. Cl. 345/107

(57) ABSTRACT

An electrophoretic display panel (1), comprises a plurality of picture elements (2); and drive means (100), for providing overreset pulses prior to application of grey scale pulses. The display panel comprises two or more interspersed groups of display elements. Each group is supplied with its own scheme (I, II) of overreset potential differences, the application schemes for overreset potential differences differs from group to group in such manner that the time at which an overreset condition is maintained differs between said groups for at least some transitions.

The invention relates to an electrophoretic display panel, comprising:
an electrophoretic medium comprising charged particles;
a plurality of picture elements;
electrodes associated with each picture element for receiving a potential difference; the charged particles being able to occupy extreme positions near the electrodes and intermediate positions in between the electrodes; the extreme positions being associated with extreme optical states; and
drive means,
   the drive means being arranged for providing to each of the plurality of picture elements
a reset potential difference having a reset value and a reset duration during a reset period for causing the charged particles to substantially occupy one of the extreme positions, and subsequently
to be a grey scale potential difference for causing the particles to occupy the position corresponding to image information.

The invention also relates to a method for driving an electrophoretic display devices comprising a plurality of picture elements in which method reset potential differences are applied to picture elements of the display device, prior to application of grey scale potentials differences to said picture elements.

An embodiment of the electrophoretic display panel of the type mentioned in the opening paragraph is described in International Patent Application WO 02/073304.

In the described electrophoretic display panel, each picture element has, during the display of the picture, an appearance determined by the position of the particles. The position of the particles depends, however, not only on the potential difference but also on the history of the potential difference. As a result of the application of the reset potential difference the dependency of the appearance of the picture element on the history is reduced, because particles substantially occupy one of the extreme positions before a grey scale potential difference is applied. Thus the picture elements are each time reset to one of the extreme states. Subsequently, as a consequence of the gray scale potential difference, the particles occupy the position to display the grey scale corresponding to the image information. “Grey scale” is to be understood to mean any intermediate state. When the display is a black and white display, “grey scale” indeed relates to a shade of grey, when other types of colored elements are used ‘grey scale’ is to be understood to encompass any intermediate state in between extreme states.

When the image information is changed the picture elements are reset. The inventors have realized that best results are obtained when an over-reset potential difference is applied. Application of an over-reset potential difference implies, as the word ‘overreset’ implies, that when a reset potential is applied the product of the applied reset potential difference times the time period during which the reset potential difference is applied is such that in fact resetting is overdone, i.e. the reset potential difference is applied for a time considerably longer than nominally needed for resetting the picture element, i.e. to bring an element into the desired extreme state. Such an application is called herein ‘overresetting’ or ‘application of an over-reset potential difference’. The inventors have realized that during application of the over-reset potential differences the image on the display may show changes in the image which are unappealing to a viewer. In particular the change-over from one image to another may be quite unappealing. During a period a visible harsh black-and-white image is produced. This transition from one image having grey tones to another image having grey tones via a purely black-and-white image which harsh, grey toneless image is visible during some time is disturbing to the viewer. An ‘overreset potential difference’ and ‘application of an overreset potential difference’ and ‘overresetting’ thus indicates a reset potential difference that, in fact, is applied longer than nominally needed to bring a picture element in an extreme optical state.

It is an object of the invention to provide a display panel of the kind mentioned in the opening paragraph which is able to provide a more appealing change-over from one image to another.

The object is thereby achieved that the drive means are arranged for providing an over-reset potential difference prior to the application of the gray scale potential difference for over-resetting a picture element from an optical state to one of the extreme optical states, wherein the plurality of picture elements comprises two or more interspersed groups of picture elements, and in that the drive means are arranged for providing to each group an application scheme of overreset potential differences, the application schemes for overreset potential differences differing from group to group in such manner that the time period during which an overreset condition is maintained differs between said groups for at least some transitions of a picture element from an initial optical state to a final optical state via an intermediate extreme optical state.

Resetting the picture elements to one of the extreme states requires for different picture elements the application of a reset potential. In the devices in accordance with the invention an overreset potential difference is applied, i.e. as explained above, the reset potential difference is applied during such a long time period that at a certain moment within this time period an overreset condition is established. An overreset condition is a condition in which an extreme state is already reached but still the potential difference is maintained over the picture element for a period of time. Prior to application of an overreset potential an image is shown which comprises grey tones. During an initial phase of the application of the overreset potential the grey tone image is changed into a black-and-white image, i.e. an image in which each of the picture elements is in an extreme state. When the overreset condition is reached, each element is a pure white or pure black and stays so until a grey scale potential difference is applied. The image is thus retained for some period of time in this black-and-white image, and thereafter is changed to a new image comprising grey tones. Each picture element thus undergoes a transition of an initial optical state, via an extreme optical state (resetting) to a final optical state. Thus an initial image having grey tones is first changed into an intermediate image pure black and white image devoid of any grey tones during the time period in which the overreset condition applies, whereafter the image is changed into a final image with grey tones. The harsh intermediate image is visible for some time and is disturbing to the viewer.

The concept of the invention is to split the display panel and therewith the image displayed on the display panel into two or more groups of elements. For each of the groups of elements this disturbing effect occurs, i.e. the disturbing intermediate image is visible. However, the total image is comprised of two intermixed image and the sum of the effects of the groups alleviates or at least reduce the effect. To do so the period during which a pure black and white image is visible, i.e. the time period during which an overreset condition is maintained, differs from group to group, and the groups are interspersed, i.e. when viewed by a viewer from a normal viewing distances (i.e. not using a magnifying glass or other such device) the images produced by the different groups fuse into one image. Each of the groups, when seen on its own, produces the disturbing effect of showing a harsh purely black-and-white image in between grey tones comprising images. However, since the relevant time periods in which this effect is visible differ from group to group, for at least some of the transitions, and the groups are interspersed, forming one single image for the human eye, the human eye averages the effects of the groups into a composite, less disturbing, effect, and a more smooth image change-over results. “Interspersed” means that when seen by a viewer from a normal or standard viewing distances (roughly 3 times or more the diagonal dimension of the screen) the images by the individual groups fuse into one image. Some examples of such interspersed groups are for instance groups wherein even rows or even columns belong to one group, and the odd rows or columns belong to another group. The size of the columns and rows of display devices is such that at usual viewing distances they are not individually distinguishable by a viewer, therefore a division in groups comprising adjacent rows will fuse the two images into one image. Groups may also comprises pairs of columns or rows or alternating bundles comprising a small number (1, 2, 3 or 4) of columns or rows, if the dimensions of the rows and columns are small enough. Also a checker-board pattern of small dimensions may be used. Non-interspersed groups are for instance groups wherein one group comprises the left hand half of the display screen, and the other the right hand half, or one group comprises the upper half of the display screen and the other the lower half. Such groups cover different parts of the display screen and the viewer will simply see the same effect twice, only slightly different on the upper (right hand) half, then on the lower (left hand) half.

Preferably the drive means are arranged such that the application schemes for application of the overreset signals alternate between groups of picture elements between frames.

The application of overreset signals that differ between groups, has the above described positive effect of reducing the harshness of the image change-over. However, although application of the overreset pulses reduces the dependence of the image on the history of application of potentials, it is best if, seen on a longer time scale, all groups have substantially the same history of application of overreset signals. By alternating the schemes for application of overreset potential differences between the groups of picture elements between images, the differences between the groups of picture elements are minimized. So, if for instance two groups of picture elements (A, B) are used, and two application schemes I and II are used for application of overreset potential difference, in the first frame scheme I is used for group A, and scheme II for group B, and in the next frame scheme II for group A and scheme II for group B, returning to scheme I for group A and scheme II for group B in the next frame etc. With more than two groups of picture elements permutation or rotation of the application schemes would be used, which within the concept of the invention falls under “alternating”. Within preferred embodiments the schemes are alternated with each change of a frame, however, within the broader concept of the invention, the schemes may be alternated each n frames, wherein n is a small number such as 1, 2, 3.

In one embodiment the drive means are arranged to supply each group of picture elements with its own overreset potential difference, the application schemes for overreset potential differences differing from group to group only by a time difference.

In this embodiment a time difference (delay) is established between application of the overreset potential differences to the groups of elements. The application schemes are for each group basically the same in form, but are shifted in time by a delay. The application of overreset potential difference then starts and ends at different times for the different groups due to the time difference (delay) between application. This is a simple embodiment, requiring not much more than a simple waveform delay which is the same for each waveform.

In another embodiment the drive means are arranged to supply each group with its own overreset signals, the application schemes for overreset signals differing from group to group such that only a difference in the applied potential difference is established between the groups.

The effect of the application of the overreset pulses is roughly proportional to the product of the time of application and the amplitude of the applied potential difference. The onset and length of the time period during which the pure black-and-white image is visible can be regulated by the amplitude of the potential difference. A difference in amplitude of the overreset potential difference thus changes the point in time at which overreset condition is reached. The higher the amplitude, the sooner this condition is reached.

In a preferred embodiment the drive means are arranged such that the application schemes between groups of picture elements differ in that a time difference is established between groups for those transitions in which the overreset potential difference is applied during less than a maximum period, but for all groups of picture elements application of an overreset potential difference of maximum time length is synchronized within a maximum time period having a common starting point and end point, and for all groups and transitions the application of overreset potential differences do not extend in time beyond said maximum time period.

By introducing a simple, overall, waveform delay but shifted in time, as in the embodiment in which the same application scheme is used for all groups, the overall change-over time is increased. This is also the case if a simple difference in amplitude is applied. This lengthening of the overall change-over time constitutes a disadvantage, since normally the transition time, i.e. the time period needed change a displayed image into the next image, is kept as small as possible. In the preferred embodiment the application of overreset pulses of maximum time length is synchronized between groups and this disadvantage does not occur.

During overresetting the optical state of the picture element is driven from an initial optical state to one of the extreme optical state and after substantially reaching this extreme optical state the potential difference is maintained for some time. The time period needed to reach the extreme optical state depends on the initial optical state of the element. Starting from an initial white optical state, it takes longer to reach the final black optical state, then it does from an initial dark grey optical state. There is thus a maximum time period needed for overresetting a picture element, namely the time period needed to reset an element from an initial extreme optical state to the opposite extreme optical state and then maintain the potential difference for some additional time (during the so-called overreset condition). This maximum time period for an element is also for a group of elements, assuming that there will be at least some picture elements within a group of elements which require during resetting an element to reach an extreme optical state from the other extreme optical state, the minimum time period needed to overreset the group of elements as a whole. If, as in one of the above embodiments a simple time delay is introduced between the groups of picture elements, the minimum time period for overresetting the image as whole is the maximum time period for overresetting a picture element increased with the maximum time delay. In the preferred embodiment for all groups of picture elements the maximum length overreact pulses (i.e. application of overreset potential differences for the maximum time period) are synchronized, i.e. they start and end for all groups simultaneously, and are thus the same for all groups. Because of the synchronization of the maximum length overreset pulses, the image as a whole is overreset in a time period not increased in comparison to the maximum time period for overresetting a picture element. The transitions that take less time than the maximum time period, i.e. that are shorter are applied with a time difference, i.e. a delay between groups of elements. In this embodiment for some transitions, namely those where the maximum length overreset potential differences are applied all groups are applied with the same, synchronized potential differences, which explains why, in the independent claim, mention is made of ‘for at least some of the transitions’.

Preferably a time delay for application of the overreset signal is applied, which increases with decrease of the length of the overreset pulse. This constitutes an easy application scheme. The delay in application of the overreset pulse will delay the time at which all elements have reached an extreme state, thus delaying the time at which a pure black-and-white image is produced. The time at which a pure black-and-white is produced is delayed. This has a smoothing effect on the transition.

In the method in accordance with the invention the method is characterized in that overreset potential differences are applied for over-resetting a picture element from an optical state to an extreme optical state, wherein the plurality of picture elements comprises two or more interspersed groups of picture elements, and in that each group is supplied with its own scheme of overreset potential differences, the application schemes for overreset potential differences differing from group to group in such manner that the time at which an overreset condition is maintained differs between said groups for at least some transitions.

These and other aspects of the display panel of the invention will be further elucidated and described with reference to the drawings, in which:

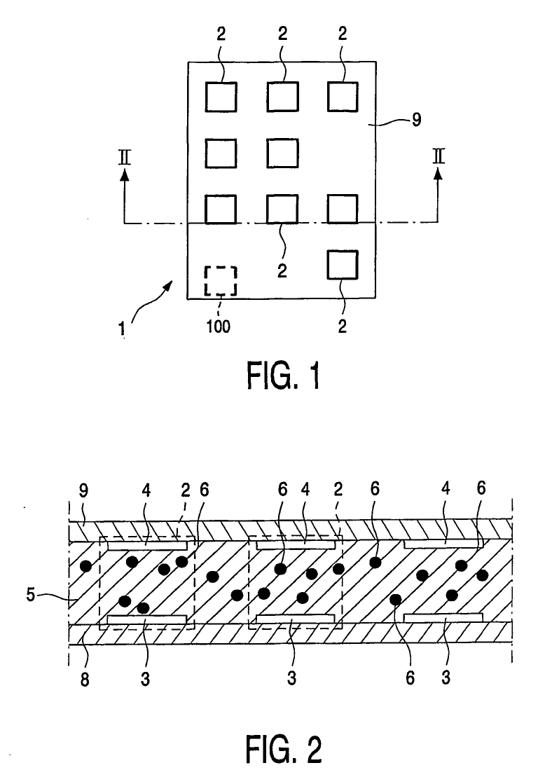

FIG. 1 shows diagrammatically a front view of an a display panel;

FIG. 2 shows diagrammatically a cross-sectional view along II-II in FIG. 1;

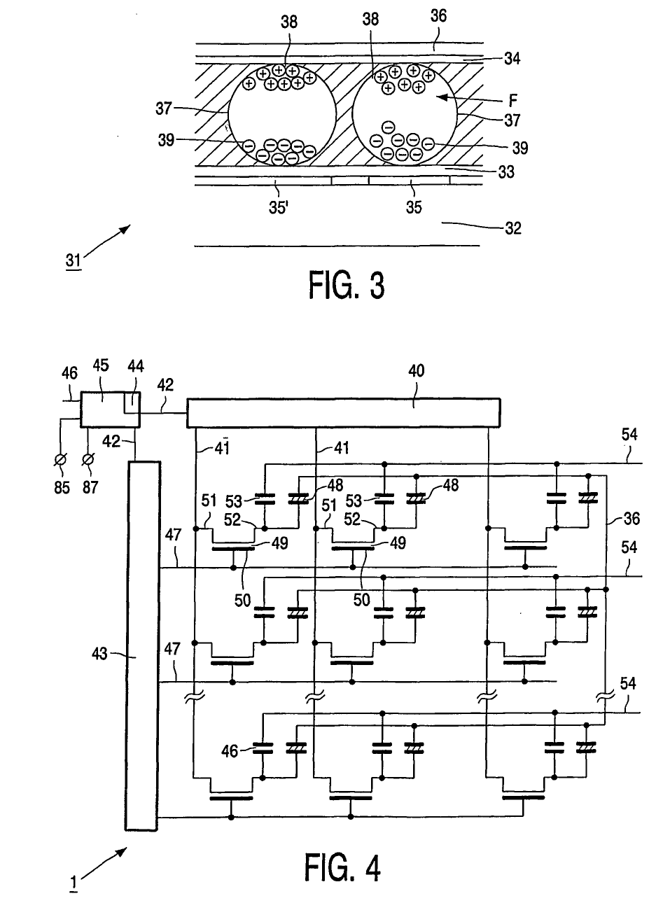

FIG. 3 shows diagrammatically a cross section of a portion of a further example of an electrophoretic display device;

FIG. 4 shows diagrammatically an equivalent circuit of a picture display device of FIG. 3;

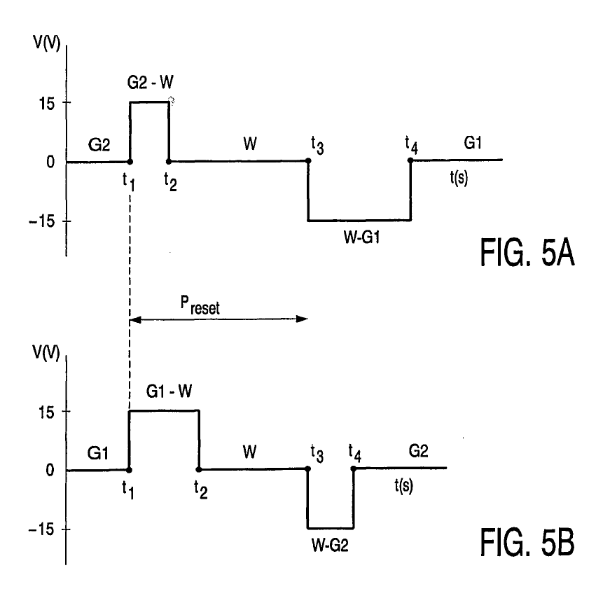

FIG. 5A shows diagrammatically the potential difference as a function of time for a picture element for one driving scheme;

FIG. 5B shows diagrammatically the potential difference as a function of time for a picture element for a further driving scheme;

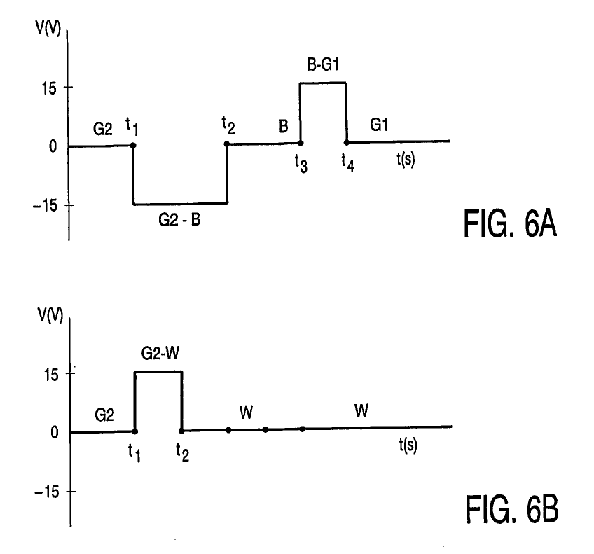

FIG. 6A shows diagrammatically the potential difference as a function of time for a picture element for a further driving scheme;

FIG. 6B shows diagrammatically the potential difference as a function of time for another picture element for a further driving scheme;

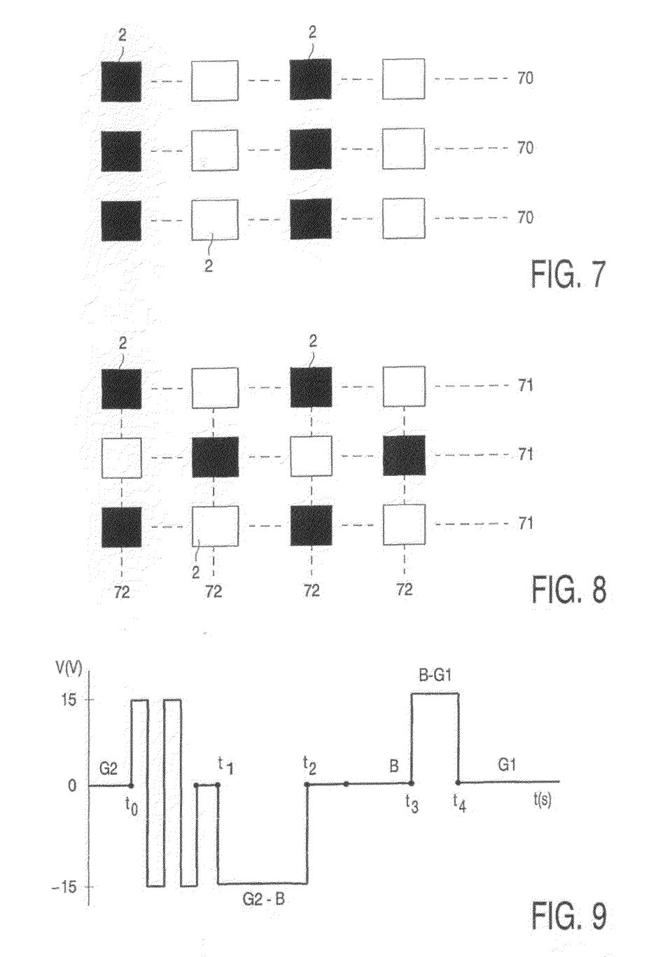

FIG. 7 shows the picture representing an average of the first and the second appearances as a result of the reset potential differences in another variation of the embodiment, and

FIG. 8 shows the picture representing an average of the first and the second appearances as a result of the reset potential differences in another variation of the embodiment.

FIG. 9 shows diagrammatically the potential difference as a function of time for a picture element.

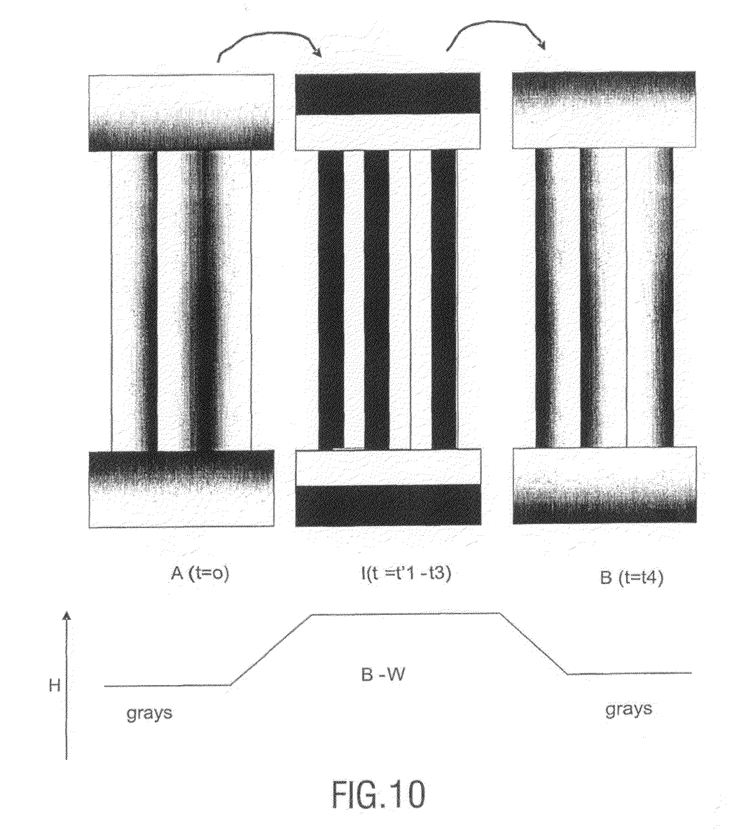

FIG. 10 illustrate a transition from an initial grey tone image A to a next grey tone image B, via an intermediate black-and-white image I.

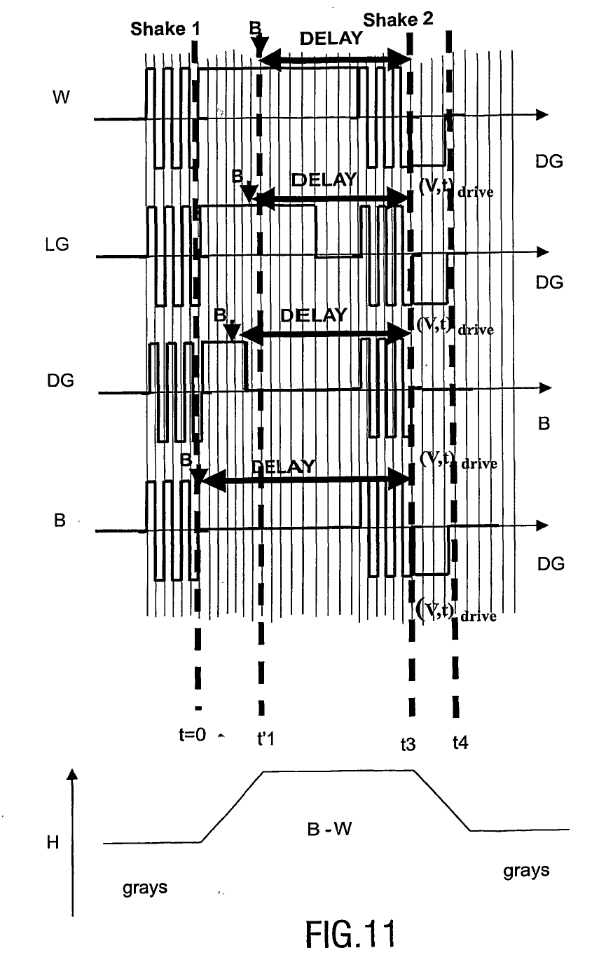

FIG. 11 illustrates a first driving scheme.

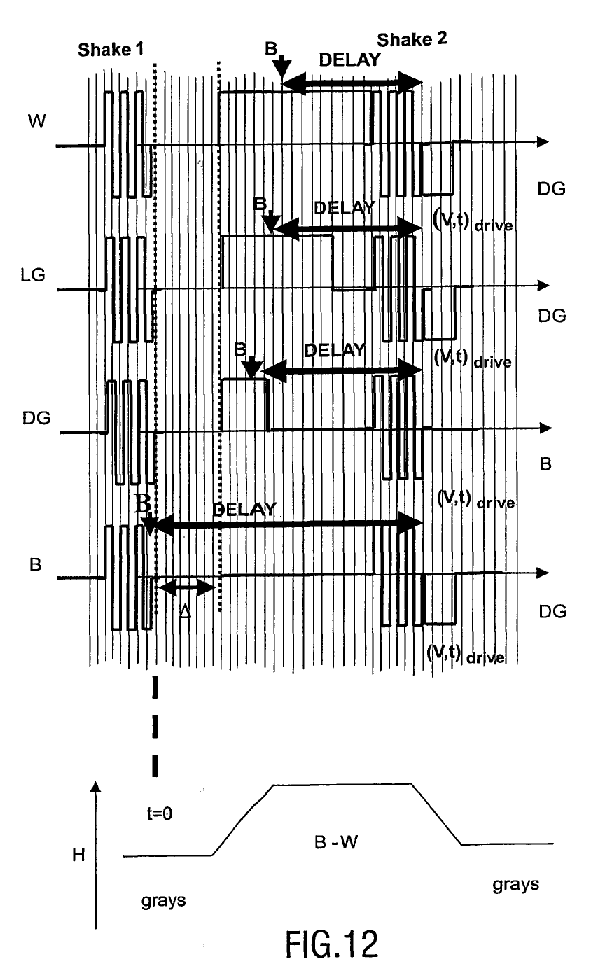

FIG. 12 illustrates a second driving scheme differing from the driving scheme of FIG. 11 in that a delay time A is added.

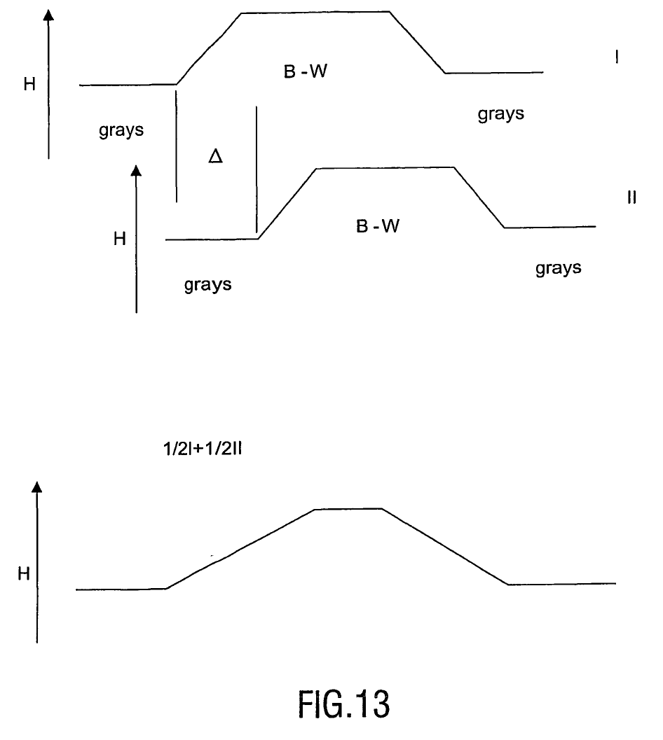

FIG. 13 illustrates the effect of two interspersed groups using the schemes of FIGS. 11 and 12.

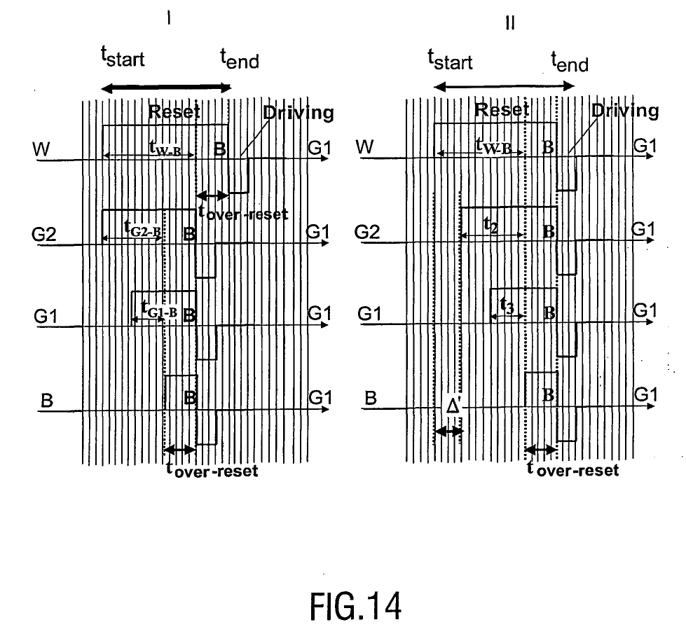

FIG. 14 illustrates a further embodiment of the invention.

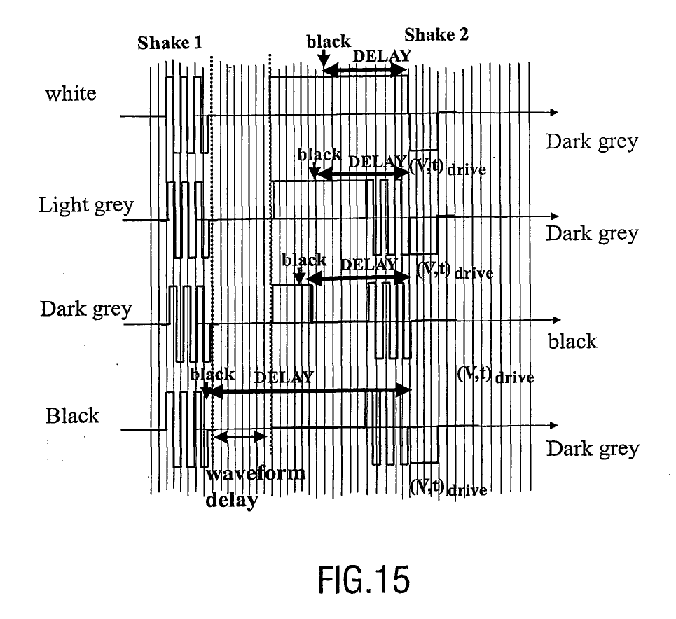

FIG. 15 illustrates still a further embodiment of the invention.

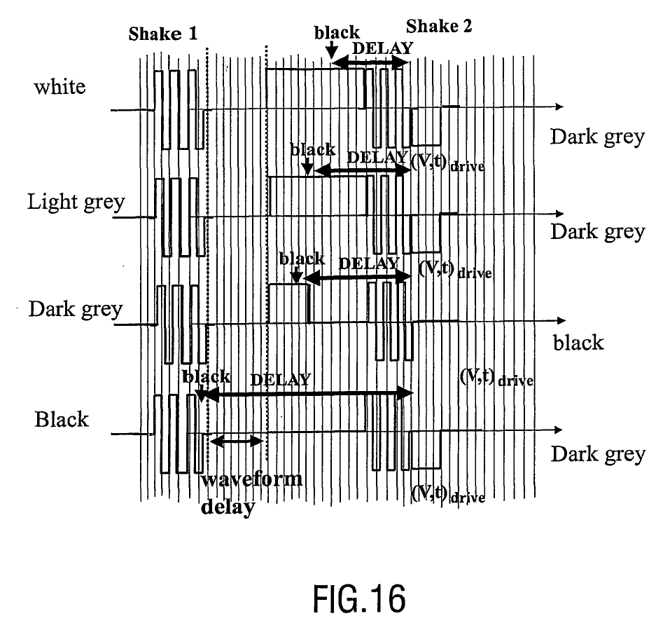

FIG. 16 illustrates a further embodiment of the invention.

In all the Figures corresponding parts are usually referenced to by the same reference numerals.

FIGS. 1 and 2 show an embodiment of the display panel 1 having a first substrate 8, a second opposed substrate 9 and a plurality of picture elements 2. Preferably, the picture elements 2 are arranged along substantially straight lines in a two-dimensional structure. Other arrangements of the picture elements 2 are alternatively possible, e.g. a honeycomb arrangement. An electrophoretic medium 5, having charged particles 6, is present between the substrates 8,9. A first and a second electrode 3,4 are associated with each picture element 2. The electrodes 3,4 are able to receive a potential difference. In FIG. 2 the first substrate 8 has for each picture element 2 a first electrode 3, and the second substrate 9 has for each picture element 2 a second electrode 4. The charged particles 6 are able to occupy extreme positions near the electrodes 3,4 and intermediate positions in between the electrodes 3,4. Each picture element 2 has an appearance determined by the position of the charged particles 6 between the electrodes 3,4 for displaying the picture. Electrophoretic media 5 are known per se from e.g. U.S. Pat. No. 5,961,804, U.S. Pat. No. 6,120,839 and U.S. Pat. No. 6,130,774 and can e.g. be obtained from E Ink Corporation. As an example, the electrophoretic medium 5 comprises negatively charged black particles 6 in a white fluid. When the charged particles 6 are in a first extreme position, i.e. near the first electrode 3, as a result of the potential difference being e.g. 15 Volts, the appearance of the picture element 2 is e.g. white. Here it is considered that the picture element 2 is observed from the side of the second substrate 9. When the charged particles 6 are in a second extreme position, i.e. near the second electrode 4, as a result of the potential difference being of opposite polarity, i.e. −15 Volts, the appearance of the picture element 2 is black. When the charged particles 6 are in one of the intermediate positions, i.e. in between the electrodes 3,4, the picture element 2 has one of the intermediate appearances, e.g. light gray, middle gray and dark gray, which are gray levels between white and black. The drive means 100 are arranged for controlling the potential difference of each picture element 2 to be a reset potential difference having a reset value and a reset duration for enabling particles 6 to substantially occupy one of the extreme positions, and subsequently to be a gray scale potential difference for enabling the particles 6 to occupy the position corresponding to the image information.

FIG. 3 diagrammatically shows a cross section of a portion of a further example of an electrophoretic display device 31, for example of the size of a few display elements, comprising a base substrate 32, an electrophoretic film with an electronic ink which is present between two transparent substrates 33, 34 for example polyethylene, one of the substrates 33 is provided with transparent picture electrodes 35 and the other substrate 34 with a transparent counter electrode 36. The electronic ink comprises multiple micro capsules 37, of about 10 to 50 microns. Each micro capsule 37 comprises positively charged white particles 38 and negative charged black particles 39 suspended in a fluid F. When a positive field is applied to the pixel electrode 35, the white particles 38 move to the side of the micro capsule 37 directed to the counter electrode 36 and the display element become visible to a viewer. Simultaneously, the black particles 39 move to the opposite side of the microcapsule 37 where they are bidden to the viewer. By applying a negative field to the pixel electrodes 35, the black particles 39 move to the side of the micro capsule 37 directed to the counter electrode 36 and the display element become dark to a viewer (not shown). When the electric field is removed the particles 38, 39 remain in the acquired state and the display exhibits a bi-stable character and consumes substantially no power. The particles may be black and white, but may be also be colored. In this respect it is remarked that “grey scale” is to be understood to mean any intermediate state. When the display is a black and white display, “grey scale” indeed relates to a shade of grey, when other types of colored elements are used ‘grey scale’ is to be understood to encompass any intermediate state in between extreme states.

FIG. 4 shows diagrammatically an equivalent circuit of a picture display device 31 comprising an electrophoretic film laminated on a base substrate 32 provided with active switching elements, a row driver 46 and a column driver 40. Preferably, a counter electrode 36 is provided on the film comprising the encapsulated electrophoretic ink, but could be alternatively provided on a base substrate in the case of operation using in-plane electric fields. The display device 31 is driven by active switching elements, in this example thin film transistors 49. It comprises a matrix of display elements at the area of crossing of row or selection electrodes 47 and column or data electrodes 41. The row driver 46 consecutively selects the row electrodes 47, while a column driver 40 provides a data signal to the column electrode 41. Preferably, a processor 45 firstly processes incoming data 43 into the data signals. Mutual synchronization between the column driver 40 and the row driver 46 takes place via drive lines 42. Select signals from the row driver 46 select the pixel electrodes 42 via the thin film transistors 49 whose gate electrodes 50 are electrically connected to the row electrodes 47 and the source electrodes 51 are electrically connected to the column electrodes 41. A data signal present at the column electrode 41 is transferred to the pixel electrode 52 of the display element coupled to the drain electrode via the TFT. In the embodiment, the display device of FIG. 3 also comprises an additional capacitor 53 at the location at each display element 48. In this embodiment, the additional capacitor 53 is connected to one or more storage capacitor lines 54. Instead of TFT other switching elements can be applied such as diodes, MIM's, etc.

As an example the appearance of a picture element of a subset is light gray, denoted as G2, before application of the reset potential difference. Furthermore, the picture appearance corresponding to the image information of the same picture element is dark gray, denoted as G1. For this example, the potential difference of the picture element is shown as a function of time in FIG. 5A. The reset potential difference has e.g. a value of 15 Volts and is present from time t₁ to time t₂, t₃ being the maximum reset duration, i.e. the reset period Preset. The reset duration and the maximum reset duration are e.g. 50 ms and 300 ms, respectively. As a result the picture element has an appearance being substantially white, denoted as W. The gray scale potential difference is present from time t₃ to time t₄ and has a value of e.g. −15 Volts and a duration of e.g. 150 ms. As a result the picture element has an appearance being dark gray (G1), for displaying the picture.

The maximum reset duration, i.e. the complete reset period, for each picture element of the subset is substantially equal to the period time required to change the position of particles 6 of the respective picture element from one of the extreme positions to the other one of the extreme positions. For the picture element in the example the reference maximum reset duration is e.g. 300 ms.

As a further example the potential difference of a picture element is shown as a function of time in FIG. 5B. The appearance of the picture element is dark gray (G1) before application of the reset potential difference. Furthermore, the picture appearance corresponding to the image information of the picture element is light gray (G2). The reset potential difference has e.g. a value of 15 Volts and is present from time t₁ to time t₂. The reset duration is e.g. 150 ms. As a result the picture element has an appearance being substantially white (W). The gray scale potential difference is present from time t3 to time t4 and has e.g. a value of e.g. −15 Volts and a duration of e.g. 50 ms. As a result the picture element has an appearance being light gray (G2), for displaying the picture. In the devices in accordance with the invention an overreset pulse is applied, i.e. the length and/or amplitude of the reset pulse between t₁ and t₂ is more powerful or applied for a longer time period than nominally needed to bring the element into the desired extreme state. The application of an overreset has the advantage that any residual history effect is eliminated. It is absolutely sure that the picture element is in an extreme optical state.

In another variation of the embodiment the drive means 100 are further arranged for controlling the reset potential difference of each picture element to enable particles 6 to occupy the extreme position which is closest to the position of the particles 6 which corresponds to the image information. As an example the appearance of a picture element is light gray (G2) before application of the reset potential difference. Furthermore, the picture appearance corresponding to the image information of the picture element is dark gray (G1). For this example, the potential difference of the picture element is shown as a function of time in FIG. 6A. The reset potential difference has e.g. a value of −15 Volts and is present from time t₁ to time t₂. The reset duration is e.g. 150 ms. As a result, the particles 6 occupy the second extreme position and the picture element has a substantially black appearance, denoted as B, which is closest to the position of the particles 6 which corresponds to the image information, i.e. the picture element 2 having a dark gray appearance (G1). The gray scale potential difference is present from time t3 to time t4 and has e.g. a value of e.g. 15 Volts and a duration of e.g. 50 ms. As a result the picture element 2 has an appearance being dark gray (G1), for displaying the picture. As another example the appearance of another picture element is light gray (G2) before application of the reset potential difference. Furthermore, the picture appearance corresponding to the image information of this picture element is substantially white (W). For this example, the potential difference of the picture element is shown as a function of time in FIG. 6B. The reset potential difference has e.g. a value of 15 Volts and is present from time t₁ to time t₂. The reset duration is e.g. 50 ms. As a result, the particles 6 occupy the first extreme position and the picture element has a substantially white appearance (W), which is closest to the position of the particles 6 which corresponds to the image information, i.e. the picture element 2 having a substantially white appearance. The gray scale potential difference is present from time t₃ to time t₄ and has a value of 0 Volts because the appearance is already substantially white, for displaying the picture.

In FIG. 7 the picture elements are arranged along substantially straight lines 70. The picture elements have substantially equal first appearances, e.g. white, if particles 6 substantially occupy one of the extreme positions, e.g. the first extreme position. The picture elements have substantially equal second appearances, e.g. black, if particles 6 substantially occupy the other one of the extreme positions, e.g. the second extreme position. The drive means are further arranged for controlling the reset potential differences of subsequent picture elements 2 along on each line 70 to enable particles 6 to substantially occupy unequal extreme positions. FIG. 7 shows the picture representing an average of the first and the second appearances as a result of the reset potential differences. The picture represents substantially middle gray.

In FIG. 8 the picture elements 2 are arranged along substantially straight rows 71 and along substantially straight columns 72 being substantially perpendicular to the rows in a two-dimensional structure, each row 71 having a predetermined first number of picture elements, e.g. 4 in FIG. 8, each column 72 having a predetermined second number of picture elements, e.g. 3 in FIG. 8. The picture elements have substantially equal first appearances, e.g. white, if particles 6 substantially occupy one of the extreme positions, e.g. the first extreme position. The picture elements have substantially equal second appearances, e.g. black, if particles 6 substantially occupy the other one of the extreme positions, e.g. the second extreme position. The drive means are further arranged for controlling the reset potential differences of subsequent picture elements 2 along on each row 71 to enable particles 6 to substantially occupy unequal extreme positions, and the drive means are further arranged for controlling the reset potential differences of subsequent picture elements 2 along on each column 72 to enable particles 6 to substantially occupy unequal extreme positions. FIG. 8 shows the picture representing an average of the first and the second appearances as a result of the reset potential differences. The picture represents substantially middle gray, which is somewhat smoother compared to the previous embodiment.

In variations of the device the drive means are further arranged for controlling the potential difference of each picture element to be a sequence of preset potential differences before being the reset potential difference. Preferably, the sequence of preset potential differences has preset values and associated preset durations, the preset values in the sequence alternate in sign, each preset potential difference represents a preset energy sufficient to release particles 6 present in one of the extreme positions from their position but insufficient to enable said particles 6 to reach the other one of the extreme positions. As an example the appearance of a picture element is light gray before the application of the sequence of preset potential differences. Furthermore, the picture appearance corresponding to the image information of the picture element is dark gray. For this example, the potential difference of the picture element is shown as a function of time in FIG. 9. In the example, the sequence of preset potential differences has 4 preset values, subsequently 15 Volts, −15 Volts, 15 Volts and −15 Volts, applied from time to time t₁. Each preset value is applied for e.g. 20 ms. Subsequently, the reset potential difference has e.g. a value of −15 Volts and is present from time t₁ to time t₂. The reset duration is e.g. 150 ms. As a result, the particles 6 occupy the second extreme position and the picture element has a substantially black appearance. The gray scale potential difference is present from time t₃ to time t₄ and has e.g. a value of e.g. 15 Volts and a duration of e.g. 50 ms. As a result the picture element 2 has an appearance being dark gray, for displaying the picture. Without being bound to a particular explanation for the mechanism underlying the positive effects of application of the preset pulses, it is presumed that the application of the preset pulses increases the momentum of the electrophoretic particles and thus shortens the switching time, i.e. the time necessary to accomplish a switch-over, i.e. a change in appearance. It is also possible that after the display device is switched to a predetermined state e.g. a black state, the electrophoretic particles are “frozen” by the opposite ions surrounding the particle. When a subsequent switching is to the white state, these opposite ions have to be timely released, which requires additional time. The application of the preset pulses speeds up the release of the opposite ions thus the de-freezing of the electrophoretic particles and therefore shortens the switching time.

As explained above, the accuracy of the greyscales in electrophoretic displays is strongly influenced by image history, dwell time, temperature, humidity, lateral inhomogeneity of the electrophoretic foils etc. Using reset pulses accurate grey levels can be achieved since the grey levels are always achieved either from reference black (B) or from reference white state (W) (the two extreme states). The pulse sequence usually consists of two to four portions: shaking pulses (optionally, hereinfurther also called shake 1), reset pulse, shaking pulses (optionally, hereinfurther also called shake 2) and greyscale driving pulse.

As explained in the above given examples an overreset potential is used. Application of an overreset potential drives each picture element and thus the image to a pure black-and-white state which is subsequently maintained for some period of time. So, starting from an image comprising grey tones and changing over to another image having grey tones, an intermediate image of pure black-and-white is visible. This intermediate image is visible to the viewer. FIG. 10 illustrates the transition, staring from a grey tone image A at t=0, another grey tone image B is produced. An intermediate pure black-and-white image I is visible between the times t′1 and t3. Below the figure an arbitrary harshness factor H is schematically indicated. In between times t′1 and t3, i.e. when an overreset condition is maintained, a harsh image is shown. This is a disturbing effect. It is to be remarked that for instance a slight lateral shift of a grey tone image which otherwise stays the same will produce such an effect. The harsh image is clearly visible. The reason why this pure black-and-white image is visible is explained by way of example in FIG. 11.

The application schemes for four transitions, from White (W) to Dark Grey (DG), from Light Grey (LG) to Dark Grey (DG), from Dark grey (DG) to Black (B) and from Black (B) to Dark grey (DG) are shown, one below the other. Each wave form comprises a first preset signal (Shake 1), an overreset signal, a second preset signal (shake 2), and finally a grey scale potential difference (V,t)_{drive}. At some time during application of the overreset signal the element reaches a final optical state, which in this case is black. This point is indicated by the arrow B. From that point onwards, the element remains in the final state, i.e. is totally black. Similar figures may be made for a transition via an intermediate extreme white optical state. Up until time t=0 the original grey tone image is visible. The elements change to black, and all elements are black at time t′1. At time t3 the optical state of the elements changes again up until time t4 at which point the grey tone image B is visible. This scheme shows that in the period between t′1 and t3 all elements are black. During this time period a pure black-and-white image is visible.

FIG. 12 shows the scheme of FIG. 11 with one change, the application of the overreset potential difference is delayed by a delay time Δ. As can be seen at the bottom of the figure this does not really improve matters The pure black-and-white image is visible for an equally long time period, only delayed by the delay Δ. However, although the visible effect for both schemes is the same, a combination of the schemes wherein the elements are divided in two groups that are so distributed over the screen that the human eye sees an average image will reduce the effect.

Schematically this is shown in FIG. 13. The top part shows schematically the harshness index H for the schemes I (FIG. 11) and II (FIG. 12). When the elements are split in two interspersed groups the total effect is schematically shown in the lower half of FIG. 13, showing a much more gradual change between the images, since the time period at which the harshness factor H is at a maximum (top of the curve) is reduced by the delay Δ.

FIGS. 11 and 12 illustrate a simple embodiment of the invention in which a simple time delay Δ characterizes the difference in waveforms of applied overreset potential differences between the groups. In this example two groups (I, II) are used. Within the framework of the invention more than two groups may be used, where in general, the more groups are used, the smoother the transition may be made, but the more complicated the electronics. Another possible embodiment is one in which the difference between the groups lies not so much in a time delay, but in a difference in amplitude (voltage) of the applied overreset potential difference. The effect of the application of the overreset pulses is roughly proportional to the product of the time of application and the amplitude of the applied potential difference. The onset and length of the time period during which the pure black-and-white image is visible can be regulated by the amplitude of the potential difference. A difference in amplitude of the overreset potential difference thus change the time at which overreset condition is reached. The higher the amplitude, the sooner this condition is reached.

Such embodiments are relatively simple, but have the disadvantage that as can be seen in FIG. 13, the total transition time is increased, e.g. by the delay time Δ. In the example shown the time difference is affixed time difference i.e. the same for all transitions, which is a preferred embodiment. It is remarked that in embodiments the time difference could be different for different transitions.

FIG. 14 illustrates an example of an embodiment of the invention in which this is not the case. In the schemes the nominal time required for transition of an initial state to black is denoted by t_{initial state-B} where the initial state is White (W), light grey (G2), and dark grey (G1). The time period longer than the nominally required is denoted as tₒᵥₑᵣ₋ᵣₑₛₑₜ. In both schemes the waveform for the application of the overreset potential difference of longest duration (from White (W) to black (B)) is the same, starts at the same point in time, and ends at the same point in time. None of the waveforms for other transitions exceed these starting or end points. When comparing the left hand scheme I to the right hand scheme II the overreset conditions for three of the four transition show a shift Δ′ in time, but not for the longest transition (from W to B) which has not been shifted. As a consequence a smoothing effect occurs when two interspersed groups using schemes I and II are used, without lengthening of the time period needed for the overresetting.

In this embodiment the drive means are arranged such that the application schemes between groups (I, II) differ in that a time difference (Δ′) is established between groups for transitions (G2-B, G1-B, B-B), in which the overreset potential difference is applied during less than a maximum period, and for all groups application of an overreset potential difference of maximum time length (W−B) are synchronized within a maximum time period having a starting point (tₛₜₐᵣₜ) and an end point (t_{end}), and for all groups and transitions the application of overreset potential differences do not extend beyond said maximum time period. The time difference may be and preferably is of constant length. This simplifies the difference between the schemes.

FIGS. 15 and 16 illustrate further embodiments of the invention whereby a common time delay Δ is applied to a second scheme, but have the advantage that the total transition time is not increased.

FIG. 15 shows the scheme of FIG. 11 with two changes, the application of the overreset potential difference is delayed by a delay time Δ and the second shaking pulse has been removed from the longest transition, in this example from white (W) to dark grey (G1). In this example, the delay time A is set identical to the duration of the second shaking pulses whereby no increase in total transition time results. In further examples, different delay times A could be used. If these are shorter than the second shaking pulses then again no increase in total transition time results. If these are longer than the second shaking pulses then an increase in total transition time results, but a smaller increase than would have resulted if the second shaking pulse were not removed from the longest waveform. Again, although the visible delay effect for both schemes is similar, a combination of the schemes wherein the elements are divided in two groups that are so distributed over the screen that the human eye sees an average image will reduce the effect.

FIG. 16 shows the scheme of FIG. 11 with two changes, the application of the overreset potential difference is delayed by a delay time Δ and the duration of the overreset potential difference reduced for the longest transition, in this example from white (W) to dark grey (G1). In this example, the delay time Δ is set identical to the reduction in the duration of the over-reset potential difference whereby no increase in total transition time results. In further examples, different delay times A could be used. If these are shorter than the reduction in the duration of the over-reset potential difference then again no increase in total transition time results. If these are longer than the reduction in the duration of the overreset potential difference then an increase in total transition time results, but a smaller increase than would have resulted if the second shaking pulse were not removed from the longest waveform. Again, although the visible delay effect for both schemes is similar, a combination of the schemes wherein the elements are divided in two groups that are so distributed over the screen that the human eye sees an average image will reduce the effect.

It is remarked that FIGS. 11, 12, 14, 15 and 16 illustrate embodiments having negatively charged white particles and positive black particles. For the invention it does not make a difference whether the white particles are negative charged and the black positively or vice versa.

The advantage is that the transition time is not increased, the disadvantage is that more complex driving schemes must be implemented.

The application of overreset signals that differ between groups, has the above described positive effect of reducing the harshness of the image change-over. However, although application of the overreset pulses reduces the dependence of the image on the history of application of potentials, and using the devices and methods in accordance with the invention a more smooth image transition is provided, it is best if, seen on a longer time scale, all groups have substantially the same history of application of overreset signals. By alternating the schemes for application of overreset signals between the groups between images, the differences between the groups are minimized. So, if for instance two groups (A, B) are used, and two schemes I and II are used for application of overreset potential difference, in the first frame scheme I is used for group A, and scheme II for group B, and in the next frame scheme II for group A and scheme II for group B, returning to scheme I for group A and scheme II for group B in the next frame etc. With more than two groups permutation or rotation of the schemes would be used, which within the concept of the invention falls under “alternating”. Within preferred embodiments the schemes are alternated with each change of a frame, however, within the broader concept of the invention, the schemes may be alternated each n frames, wherein n is a small number such as 1, 2, 3. The advantage of alternating every second or third frame instead of every frame is that it is simpler.

It is remarked that the plurality of display elements divided into interspersed groups may cover all of the display screen of the display device and often will do so, but such is not necessary within a broad concept of the invention, it may relate to a part of a larger screen. For instance if there is a first part of the display screen for which the image changes regularly and comprises grey tones (e.g. to photographs), while another part of the display screen is used to display pure black and white images (black text on a white background for instance), the invention may be used for the first part, and not for the second part of the display screen.

In short the invention may be described as follows:

An electrophoretic display panel (1), comprises a plurality of picture elements (2); and drive means (100), for providing overreset pulses prior to application of grey scale pulses. The display panel comprises two or more interspersed groups of display elements. Each group is supplied with its own scheme (I, II) of overreset potential differences, the application schemes for overreset potential differences differs from group to group in such manner that the time at which an overreset condition is maintained differs between said groups for at least some transitions.

In embodiments the time at which an overreset condition is maintained differs for all transition where an over-reset is applied.

It is remarked that the division in groups may be fixed and the allocation of schemes to groups may be fixed, for instance wherein a first scheme of overreset pulses is supplied to even rows of display elements, and a second, different, scheme is used for odd rows, the groups may be fixed but the allocation may vary, for instance between frames, but also the groups need not be fixed, for instance wherein in one frame a division is made in two groups, comprising odd rows and even rows respectively, in the next frame three groups are used, etc. etc.

It will be appreciated by persons skilled in the art that the present invention is not limited by what has been particularly shown and described hereinabove. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

The invention is also embodied in any computer program comprising program code means for performing a method in accordance with the invention when said program is run on a computer as well as in any computer program product comprising program code means stored on a computer readable medium for performing a method in accordance with the invention when said program is run on a computer, as well as any program product comprising program code means for use in display panel in accordance with the invention, for performing the action specific for the invention.

The present invention has been described in terms of specific embodiments, which are illustrative of the invention and not to be construed as limiting. The invention may be implemented in hardware, firmware or software, or in a combination of them. Other embodiments are within the scope of the following claims.

1. An electrophoretic display panel (1), comprising:
an electrophoretic medium (5) comprising charged particles (6);
a plurality of picture elements (2);
electrodes (3,4) associated with each picture element (2) for receiving a potential difference; the charged particles being able to occupy extreme positions near the electrodes and intermediate positions in between the electrodes; the extreme positions being associated with extreme optical states; and
drive means (100),
the drive means (100) being arranged for providing to each picture element (2)
a reset potential difference for causing particles (6) to substantially occupy one of the extreme positions, and subsequently
a grey scale potential difference for causing the particles (6) to occupy the position corresponding to the image information,
characterized in that the drive means (100) are arranged for providing an over-reset potential difference prior to the application of the gray scale potential difference for over-resetting a picture element from an optical state to one of the extreme optical states, wherein the plurality of picture elements comprises two or more interspersed groups of picture elements, and in that the drive means are arranged for providing each group with its own application scheme (I, II) of overreset potential differences, the application schemes for overreset potential differences differing from group to group in such manner that the time period during which an overreset condition is maintained differs between said groups for at least some transitions of a picture element from an initial optical state to a final optical state via an extreme optical state.

2. An electrophoretic display device as claimed in claim 1, wherein the drive means are arranged to provide overreset potential differences such that the application schemes for application of the overreset signals alternate between groups between frames.

3. An electrophoretic display panel as claimed in claim 1, wherein the drive means are arranged to supply each group of picture element with its own overreset potential difference, the application schemes for overreset potential differences differing from group to group only by a time difference (Δ).

4. An electrophoretic display panel as claimed in claim 1, wherein the drive means are arranged to supply each group with its own overreset signals, the application schemes for overreset signals differing from group to group such that only a difference in the applied potential difference is established between the groups.

5. An electrophoretic display panel as claimed in claim 1, wherein the drive means are arranged such that the application schemes (I, II) between groups of picture elements differ in that a time difference (Δ′) is established between groups for those transitions (G2-B, G1-B, B-B) in which the overreset potential difference is applied during less than a maximum period, but, for all groups of picture elements, application of an overreset potential difference of maximum time length (W−B) are synchronized within a maximum time period having a common starting point (tₛₜₐᵣₜ) and an end point (t_{end}), and for all groups and transitions the application of overreset potential differences do not extend in time beyond said maximum time period (tₛₜₐᵣₜ−t_{end}).

6. A method for driving an electrophoretic display devices comprising a plurality of picture elements in which method reset potential differences are applied to picture elements of the display device, prior to application of grey scale potential differences to said picture elements, characterized in that over-reset potential differences for over-resetting a picture element from an optical state to an extreme optical state are applied, wherein the plurality of picture elements comprises two or more interspersed groups of picture elements, and in that each group is supplied with its own scheme of overreset potential differences, the application schemes for overreset potential differences differing from group to group in such manner that the time period at which an overreset condition is maintained differs between said groups of picture elements for at least some transitions of a picture element from an initial optical state to a final optical state via an intermediate optical state.

7. A method as claimed in claim 6, wherein the overreset potential differences are applied such that the application schemes for application of the overreset signals alternate between groups between frames.

8. A method as claimed in claim 6, wherein each group is supplied with its own overreset potential difference, the application schemes for overreset potential differences differing from group to group only by a time difference (Δ).

9. A method as claimed in claim 6, wherein each group with its own overreset signals, the application schemes for overreset signals differing from group to group such that only a difference in the applied potential difference is established between the groups.

10. Computer program comprising program code means for performing a method in accordance with the method as claimed in claim 6 when said program is run on a computer.

11. Computer program product comprising program code means stored on a computer readable medium for performing a method in accordance with the method as claimed in claim 6 when said program is run on a computer.

12. Drive means for an electrophoretic display panel as claimed in claim 1.
